(19) United States
(12) Patent Application Publication
(10) Pub. No.: US 2010/0027973 A1
(43) Pub. Date: Feb. 4, 2010

(54) IMAGE PROCESSING CIRCUIT AND METHOD CAPABLE OF PERFORMING ONLINE COLOR SPACE CONVERSION

(76) Inventors: Chia-Yun Cheng, Hsinchu City (TW); Chi-Cheng Ju, Hsinchu City (TW); Chi-Chin Lien, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/181,326

(22) Filed: Jul. 29, 2008

(51) Int. Cl. H04N 5/93

(52) U.S. Cl. 386/109; 386/E05.028

(57) ABSTRACT

An image processing circuit includes: a video decoder for decoding at least one block image source to generate first decoded data, where the block image source and the first decoded data correspond to a first color space; a color space converting unit, coupled to the video decoder, for performing color space conversion on the first decoded data to generate second decoded data, where the second decoded data corresponds to a second color space; a block based scaling unit, coupled to the color space converting unit, for performing a scaling operation on the second decoded data to generate scaled data, where the scaled data corresponds to the second color space; and a frame buffer, coupled to the block based scaling unit, for temporarily storing the scaled data, where the scaled data temporarily stored in the frame buffer is utilized in the second color space.

### BACKGROUND

The present invention relates to video decoding, and more particularly, to image processing circuits and methods capable of performing online color space conversion.

As well known to those in the related art, high definition (HD) video formats typically use a color space defined by International Telecommunication Union Radiocommunication Sector (ITU-R) BT.709 (which can be referred to as Rec. 709), and standard definition (SD) video formats typically use a color space defined by ITU-R BT.601 (which can be referred to as Rec. 601). If an HD image is down-scaled to an SD image (or an SD image is up-scaled to an HD image) without performing color space conversion, color accuracy (color tone or correctness of colors) of the scaled result may be unacceptable. Therefore, it is recommended to always perform color space conversion while performing such scaling operations.

According to the related art, within a video decoding device, a circuit for performing frame based color space conversion is usually implemented within a display unit. Within the video decoding device, a video decoder may decode a block image source to temporarily store decoded data of a whole image to be displayed in a frame buffer, where a scaling unit within the video decoding device may perform scaling operations on the decoded data of the whole image if scaling is required. In addition, if the frame based color space conversion mentioned above should be performed, it is performed according to the decoded data accessed from the frame buffer when the display unit operates for displaying the whole image.

The mixing of video content for image sources of different video formats may be required when displaying a whole image. For example, referring to FIG. 1, displaying digest images 11, 12, 13, 14, and 15 respectively corresponding to a plurality of image sources of different video formats such as SD and HD video formats on a background image 10 may be required. In this situation, if it is determined to skip the frame based color space conversion, the color accuracy of the digest images may be unacceptable. Conversely, if it is determined to always perform the frame based color space conversion in order to maintain the color accuracy of the digest images, the frame based color space conversion function should be turned on or turned off accurately while the display unit operates scan line by scan line according to the decoded data accessed from the frame buffer. Therefore, implementation of the display unit (more particularly, the circuit for performing the frame based color space conversion) is very complicated and cumbersome.

### SUMMARY

It is therefore an objective of the claimed invention to provide image processing circuits and methods to solve the above-mentioned problem.

It is also an objective of the claimed invention to provide image processing circuits and methods capable of performing online color space conversion, particularly while decoding a macroblock (MB) of an image source.

It is another objective of the claimed invention to provide image processing circuits and methods capable of performing online operations of color space conversion and scaling, in order to generate data that can be directly utilized by at least one device.

It is also an objective of the claimed invention to provide image processing circuits and methods capable of performing online operations of color space conversion and scaling, in order to save memory bandwidth.

An exemplary embodiment of an image processing circuit comprises: a video decoder for decoding at least one block image source to generate first decoded data, where the block image source and the first decoded data correspond to a first color space; a color space converting unit, coupled to the video decoder, for performing color space conversion on the first decoded data to generate second decoded data, where the second decoded data corresponds to a second color space; a block based scaling unit, coupled to the color space converting unit, for performing a scaling operation on the second decoded data to generate scaled data, where the scaled data corresponds to the second color space; and a frame buffer, coupled to the block based scaling unit, for temporarily storing the scaled data, where the scaled data temporarily stored in the frame buffer is utilized in the second color space.

An exemplary embodiment of an image processing method comprises: decoding at least one block image source to generate first decoded data, wherein the block image source and the first decoded data correspond to a first color space; performing color space conversion on the first decoded data to generate second decoded data, wherein the second decoded data corresponds to a second color space; performing a scaling operation on the second decoded data to generate scaled data, wherein the scaled data corresponds to the second color space; and temporarily storing the scaled data, wherein the scaled data that is temporarily stored is utilized in the second color space.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a plurality of digest images respectively corresponding to a plurality of image sources of different video formats on a background image according to the related art.

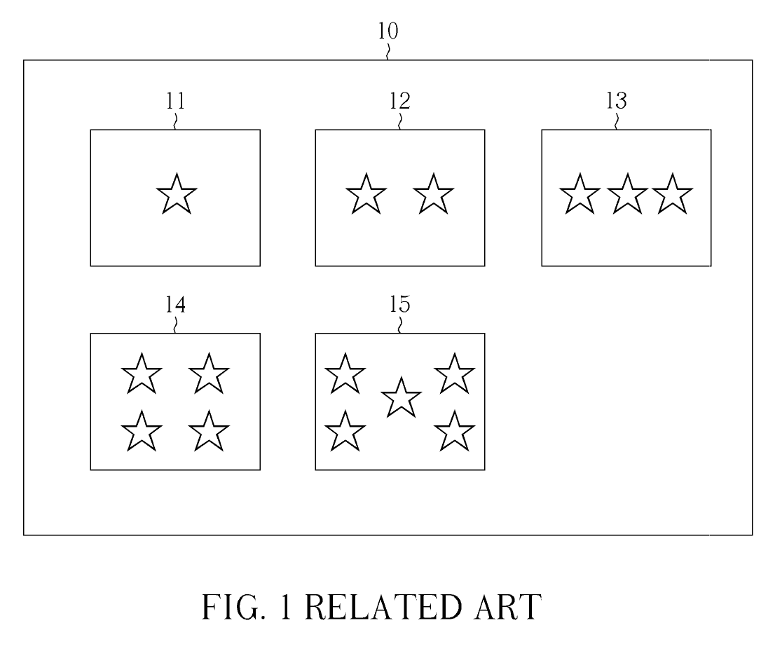

FIG. 2 is a diagram of an image processing circuit according to one embodiment of the present invention.

FIG. 3 illustrates a scaled image displayed on a background image of a standard definition (SD) video format according to one embodiment of the present invention, where the scaled image is derived from an original image of a high definition (HD) video format.

FIG. 4 illustrates a plurality of digest images respectively corresponding to a plurality of image sources of different video formats on a background image according to one embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

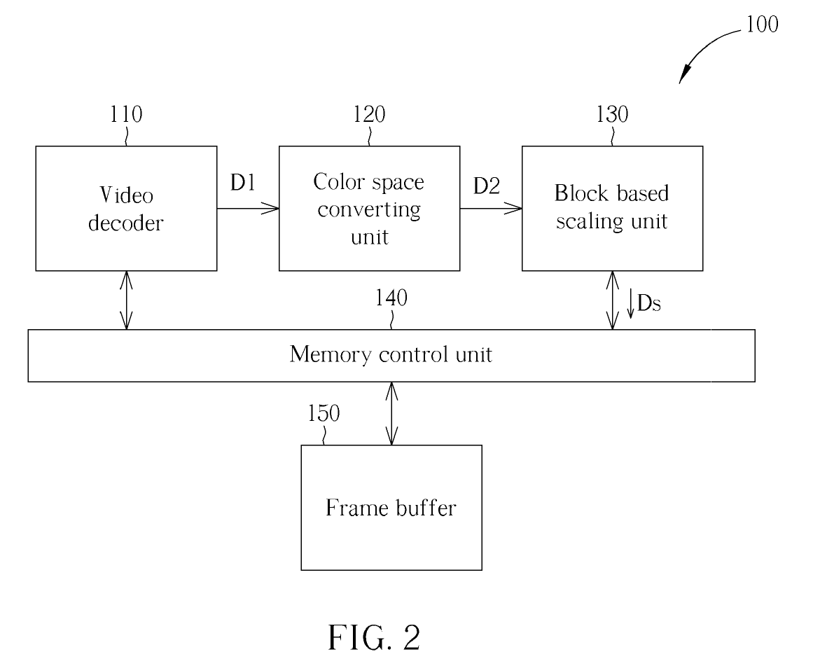

Please refer to FIG. 2. FIG. 2 is a diagram of an image processing circuit 100 according to one embodiment of the present invention. The image processing circuit 100 comprises a video decoder 110, a color space converting unit 120, a block based scaling unit 130, a memory control unit 140, and a frame buffer 150, where the frame buffer 150 of this embodiment is a random access memory (RAM), and more particularly, an SDRAM. According to an implementation choice of this embodiment, the video decoder 110, the color space converting unit 120, the block based scaling unit 130, and the memory control unit 140 can be integrated into a single chip. According to another implementation choice of this embodiment, the video decoder 110, the color space converting unit 120, the block based scaling unit 130, and the memory control unit 140 can be individual circuits.

According to this embodiment, the video decoder 110 is capable of decoding at least one block image source S1 to generate decoded data D1, where the block image source S1 and the decoded data D1 correspond to a first color space (e.g. one of the ITU-R BT.709 color space or the ITU-R BT.601 color space). Please note that the decoded data D1 are generated in accordance with a macroblock (MB), so the color space converting unit 120 of this embodiment is capable of performing color space conversion on the decoded data D1 to generate decoded data D2 in a block based manner, such that the decoded data D2 corresponds to a second color space differing from the first color space. In addition, the block based scaling unit 130 is capable of performing a scaling operation on the decoded data D2 to generate scaled data Ds, where the scaled data Ds corresponds to the second color space. As a result, the block based scaling unit 130 may temporarily store the scaled data Ds into the frame buffer 150 through the memory control unit 140, where the scaled data Ds temporarily stored in the frame buffer 150 is utilized in the second color space. Operations of the memory control unit 140 are well known in the art, and for brevity, are not explained in detail.

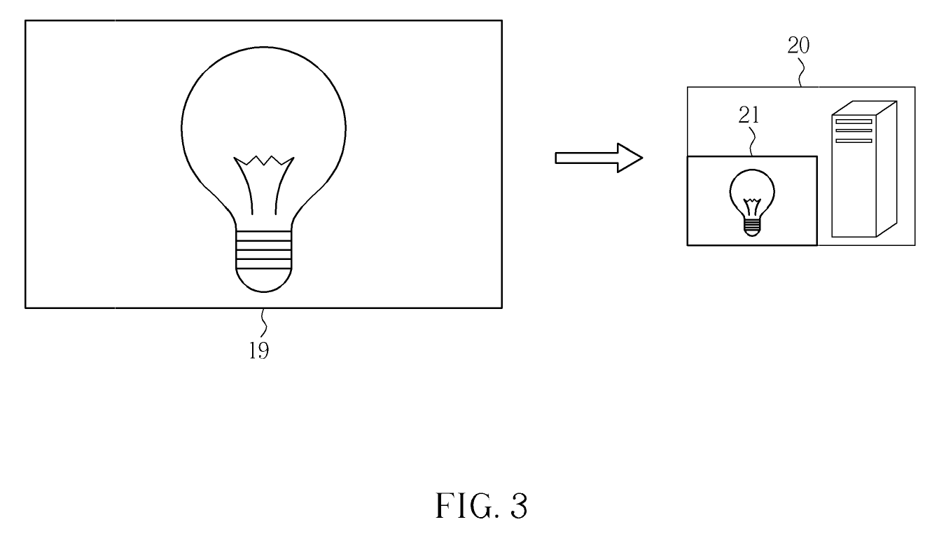

FIG. 3 illustrates a scaled image 21 displayed on a background image 20 of a standard definition (SD) video format according to one embodiment of the present invention, where the scaled image 21 is derived from an original image 19 of a high definition (HD) video format. This embodiment is a special case of the embodiment shown in FIG. 2. The original image 19 represents an image of the block image source S1 corresponding to the first color space, while the background image 20 represents an image of a block image source S2 corresponding to the second color space.

According to this embodiment, the frame buffer 150 is capable of being coupled to a display device or a display circuit thereof (not shown), which can be utilized for accessing the scaled data Ds temporarily stored in the frame buffer 150. As shown in the right half of FIG. 3, the display device is capable of displaying the scaled image 21 of the block image source S1 according to the scaled data Ds, and displaying the non-overlapped portion of the background image 20 according other decoded data D4 (not shown), which is decoded from the block image source S2 by the video decoder 110 and temporarily stored in the frame buffer 150. According to this embodiment, the decoded data D4 is generated without performing a scaling operation, where the decoded data D4 corresponds to the second color space.

As the scaled image 21 is a sub-picture being a portion of the whole image displayed by the display device, the scaled image 21 should be displayed according to the same color space utilized for displaying the background image 20, in order to maintain the color accuracy of the scaled image 21. Accordingly, while the video decoder 110 decodes a MB of the block image source S1 to generate the decoded data D1 of the MB, the color space converting unit 120 performs block based color space conversion on the decoded data D1 of the MB to generate decoded data D2 of the MB, and the block based scaling unit 130 performs a scaling operation on the decoded data D2 of the MB to generate the scaled data Ds of the MB and temporarily stores the scaled data Ds of the MB into the frame buffer 150 through the memory control unit 140. This scenario can be referred to as online color space conversion and scaling, where the operations of the video decoder 110, the color space converting unit 120, and the block based scaling unit 130 are block based operations.

In this embodiment, the first color space is the ITU-R BT.709 color space, and the second color space is the ITU-R BT.601 color space, where the scaled data Ds temporarily stored in the frame buffer 150 represents a scaled ITU-R BT.601 color space image of the block image source S1. According to a variation of this embodiment, the first color space is the ITU-R BT.601 color space, and the second color space is the ITU-R BT.709 color space, where the scaled data Ds temporarily stored in the frame buffer 150 represents a scaled ITU-R BT.709 color space image of the block image source S1.

In this embodiment, the scaling operation performed by the block based scaling unit 130 as mentioned is a down-scaling operation. According to another variation of this embodiment, a scaling operation performed by the block based scaling unit 130 is an up-scaling operation.

Also in this embodiment, the scaled data Ds is utilized by the display device mentioned above. According to another variation of this embodiment, the scaled data Ds can be further utilized by another device, for example, a recording device. In this variation, the recording device may access the scaled data Ds and the decoded data D4 that are temporarily stored in the frame buffer 150 to record the whole image as shown in the right half of FIG. 3. Here the display device can be a liquid crystal display (LCD) panel, and the recording device can be a digital video recorder.

In this embodiment, the decoded data D1 processed by the online color space conversion and scaling as mentioned, so as to be utilized by the display device mentioned above. According to another variation of this embodiment, the decoded data D1 generated by the video decoder 110 can be temporarily stored in the frame buffer 150, and further utilized by another device, such as a recording device for example. In this variation, the recording device may access the decoded data D1 that is temporarily stored in the frame buffer 150, in order to record according to the second color space. Here the display device can be an LCD panel, and the recording device can be a digital video recorder.

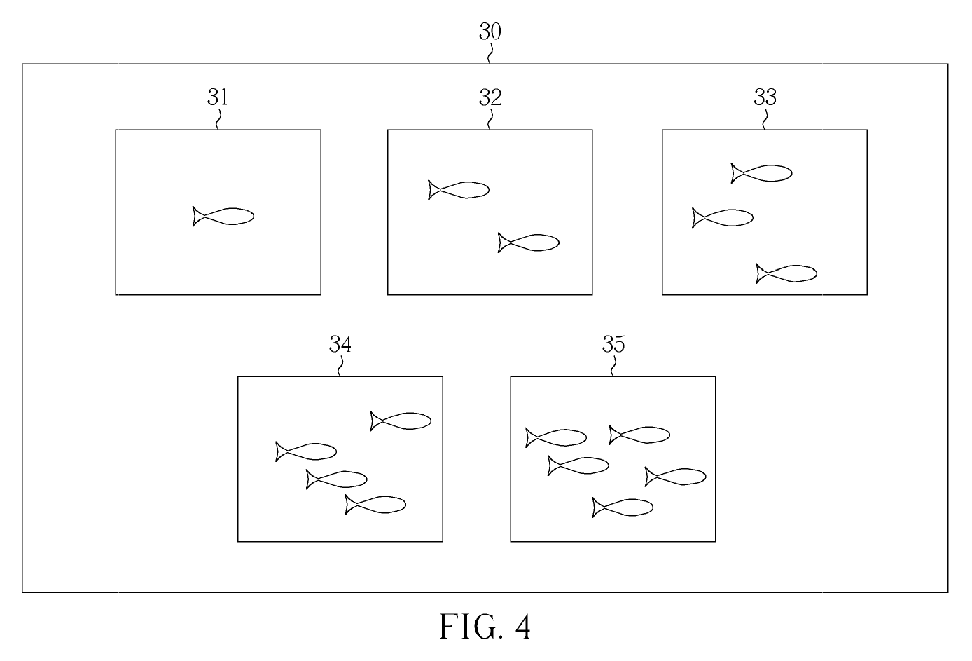

FIG. 4 illustrates a plurality of digest images 31, 32, 33, 34, and 35 respectively corresponding to a plurality of image sources of different video formats on a background image 30 according to one embodiment of the present invention. This embodiment is not only a special case of the embodiment shown in FIG. 2, but also a variation of the embodiment shown in FIG. 3. The digest images 31, 32, 33, 34, and 35 respectively correspond to five sets of (S1, D1, D2, Ds), each set of (S1, D1, D2, Ds) corresponding to one of the plurality of image sources. In addition, the background image 30 represents an image of the block image source S2 corresponding to the second color space. The scaled data Ds is displayed by the display device in a digest mode. Similar descriptions are not repeated for this embodiment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing circuit comprising:
a video decoder for decoding at least one block image source to generate first decoded data, wherein the block image source and the first decoded data correspond to a first color space;
a color space converting unit, coupled to the video decoder, for performing color space conversion on the first decoded data to generate second decoded data, wherein the second decoded data corresponds to a second color space;
a block based scaling unit, coupled to the color space converting unit, for performing a scaling operation on the second decoded data to generate scaled data, wherein the scaled data corresponds to the second color space; and
a frame buffer, coupled to the block based scaling unit, for temporarily storing the scaled data, wherein the scaled data temporarily stored in the frame buffer is utilized in the second color space.

2. The image processing circuit of claim 1, wherein the frame buffer is capable of being coupled to a display device for accessing the scaled data temporarily stored in the frame buffer, and the display device is capable of displaying an image of the block image source according to the scaled data.

3. The image processing circuit of claim 2, wherein the image of the block image source is a sub-picture being a portion of a whole image displayed by the display device.

4. The image processing circuit of claim 3, wherein the scaled data is displayed by the display device in a digest mode, and the sub-picture is one of a plurality of digest images within the whole image displayed by the display device.

5. The image processing circuit of claim 1, wherein the first color space and the second color space comprise an ITU-R BT.709 color space and an ITU-R BT.601 color space.

6. The image processing circuit of claim 5, wherein if the second color space is the ITU-R BT.709 color space, the scaled data temporarily stored in the frame buffer represents a scaled ITU-R BT.709 color space image of the block image source; and if the second color space is the ITU-R BT.601 color space, the scaled data temporarily stored in the frame buffer represents a scaled ITU-R BT.601 color space image of the block image source.

7. The image processing circuit of claim 1, wherein the scaled data or the first decoded data is utilized by at least one device.

8. The image processing circuit of claim 7, wherein the scaled data or the first decoded data is utilized by a plurality of devices comprising a display device and a recording device.

9. The image processing circuit of claim 1, wherein the video decoder further decodes another block image source to generate other decoded data, and the other block image source and the other decoded data correspond to the second color space; and the other decoded data together with the scaled data are temporarily stored in the frame buffer, so as to be utilized as at least one portion of a whole image.

10. The image processing circuit of claim 1, wherein operations of the video decoder, the color space converting unit, and the block based scaling unit are block based operations.

11. An image processing method comprising:
decoding at least one block image source to generate first decoded data, wherein the block image source and the first decoded data correspond to a first color space;
performing color space conversion on the first decoded data to generate second decoded data, wherein the second decoded data corresponds to a second color space;
performing a scaling operation on the second decoded data to generate scaled data, wherein the scaled data corresponds to the second color space; and
temporarily storing the scaled data, wherein the scaled data that is temporarily stored is utilized in the second color space.

12. The image processing method of claim 11, further comprising:
utilizing a display device or a display circuit thereof to access the scaled data that is temporarily stored, in order to display an image of the block image source according to the scaled data.

13. The image processing method of claim 12, wherein the image of the block image source is a sub-picture being a portion of a whole image displayed by the display device.

14. The image processing method of claim 13, wherein the scaled data is displayed by the display device in a digest mode, and the sub-picture is one of a plurality of digest images within the whole image displayed by the display device.

15. The image processing method of claim 11, wherein the first color space and the second color space comprises an ITU-R BT.709 color space or an ITU-R BT.601 color space.

16. The image processing method of claim 15, wherein if the second color space is the ITU-R BT.709 color space, the scaled data that is temporarily stored represents a scaled ITU-R BT.709 color space image of the block image source; and if the second color space is the ITU-R BT.601 color space, the scaled data that is temporarily stored represents a scaled ITU-R BT.601 color space image of the block image source.

17. The image processing method of claim 11, wherein the scaled data or the first decoded data is utilized by at least one device.

18. The image processing method of claim 17, wherein the scaled data or the first decoded data is utilized by a plurality of devices comprising a display device and a recording device.

19. The image processing method of claim 11, further comprising:
decoding another block image source to generate other decoded data, wherein the other block image source and the other decoded data correspond to the second color space; and
temporarily storing the other decoded data;
wherein the other decoded data together with the scaled data are temporarily stored, so as to be utilized as at least one portion of a whole image.

20. The image processing method of claim 11, wherein the step of decoding the block image source, the step of performing color space conversion on the first decoded data, and the step of performing the scaling operation on the second decoded data are block based operations.
